(19) United States
(12) Patent Application Publication
(10) Pub. No.: US 2004/0012247 A1
(43) Pub. Date: Jan. 22, 2004

(54) Wheel assembly for child bicycles

(76) Inventors: Shih-Yuan Lin, Taichung Hsien (TW); Kun-Sung Lu, Taichung Hsien (TW)

Correspondence Address: CHARLES E. BAXLEY, ESQUIRE, Hart, Baxley, Daniels & Holton, 59 John St., 5 Fl., New York, NY, 10038, US

(21) Appl. No.: 10/195,656

(22) Filed: Jul. 16, 2002

(51) Int. Cl. B60B 21/00

(52) U.S. Cl. 301/95.101

(57) ABSTRACT

A wheel assembly for child bicycles includes a rim made of Polypropylene and includes two shoulder portions with a groove located therebetween. An annular tire made of Thermoplastic Elastomers which is compatible with the Polypropylene. The tire is engaged with the groove and the shoulder portions of the rim.

### FIELD OF THE INVENTION

The present invention relates to a wheel assembly for child bicycles and includes a rim made of Polypropylene known as PP and a tire made of Thermoplastic Elastomers known as TPE mounted to the rim. The TPE and PP own similar molecular structure so that they are connected with each other firmly.

### BACKGROUND OF THE INVENTION

A conventional wheel assembly wheel for child bicycles is shown in FIG. 1 and generally includes a rim 11 and an outer tire 12 made of plastic which is securely engaged with the rim 11. A tube 13 is located between the rim 11 and the tire 12 and is inflated to support the load applied to the wheel. This type of wheel having a tube 13 has an inherent shortcoming of being penetrated by an sharp object to flat the tube 13. Once the tube 13 is flat, the wheel cannot perform normally. FIG. 2 shows another improved wheel assembly for child bicycles, and includes a rim 21 which has several protrusions 22 on an outer periphery thereof and the tire 23 is connected to the rim 21. The tire 23 is made of Ethylene-Vinyl Acetate Copolymer known as EVA and can be connected to the rim 21 by the protrusions 22. Nevertheless, the tire 23 tends to slip relative to the rim 21 that is because the two different types of material of the rim 21 and the tire 23 are not compatible.

The present invention intends to provide a wheel assembly for child bicycles wherein the tire and the rim are made of materials that are compatible.

### SUMMARY OF THE INVENTION

In accordance with one aspect of the present invention, there is provided a wheel assembly for child bicycles and the wheel assembly comprises a rim made of Polypropylene and having two shoulder portions and a groove located between the two shoulder portions in an outer periphery of the rim. An annular tire made of complex material which is compatible with the Polypropylene, is engaged with the groove and the shoulder portions of the rim.

The primary object of the present invention is to provide a wheel assembly for child bicycles and the rim and the tire are made of compatible material and the rim and the tire are securely connected.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a first type of conventional wheel assembly for child bicycles;

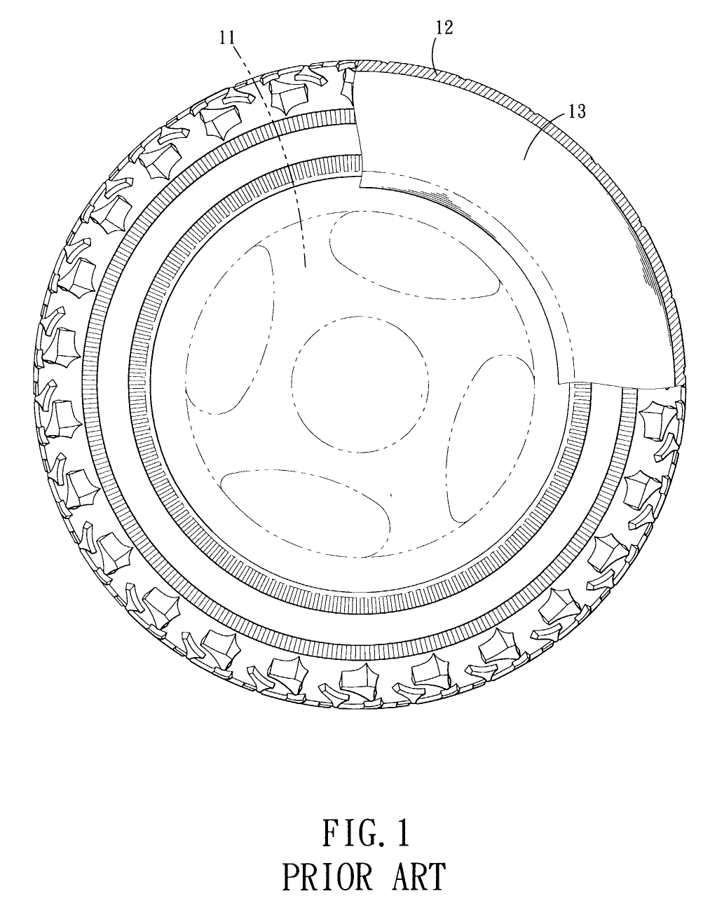

FIG. 2 is a cross sectional view to show a second type of conventional wheel assembly for child bicycles;

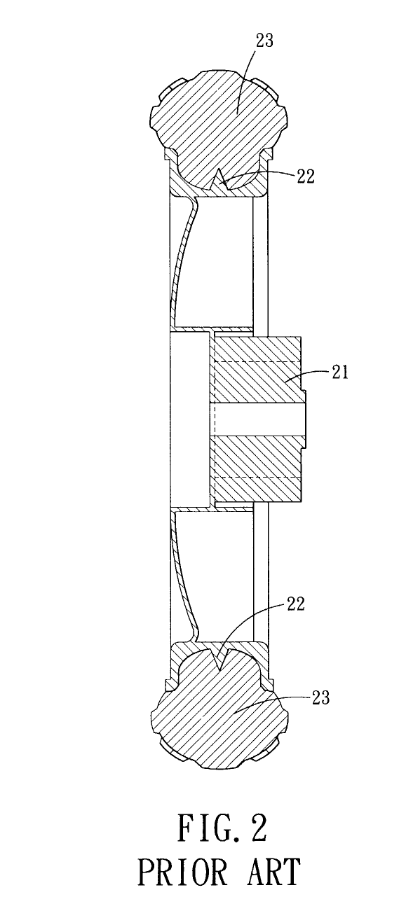

FIG. 3 is a cross sectional view to show the wheel assembly for child bicycles of the present invention, and

FIG. 4 shows another embodiment of the wheel assembly for child bicycles of the present invention.

### DETAILED DESCRIPTION OF THE PREFERRED EMBODIMENT

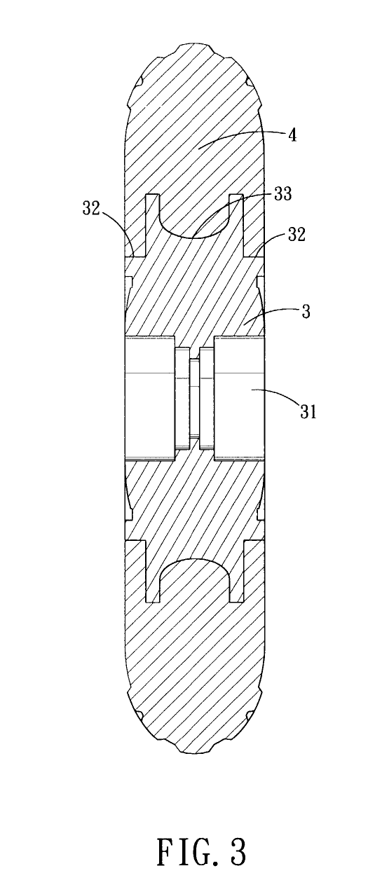

Referring to FIG. 3, the wheel assembly for child bicycles 7 of the present invention comprises a rim 3 made of Polypropylene known as P.P. and having two shoulder portions 32 on the outer periphery of the rim 3. A ridge extends from the outer periphery of the rim 3 and located between the two shoulder portions 32. A groove 33 is defined in the outer periphery of the ridge.

An annular tire 4 made of complex material such as Thermoplastic Elastomers known as TPE, which is compatible with the Polypropylene. The tire 4 is engaged with the groove 33 and the shoulder portions 32 of the rim 3. Because the TPE and the PP. have similar molecular structure so that they are well connected with each other. The tire 4 is solid and flexible so that the wheel assembly needs not to be pumped and both of the TPE and the P.P. can be recycled.

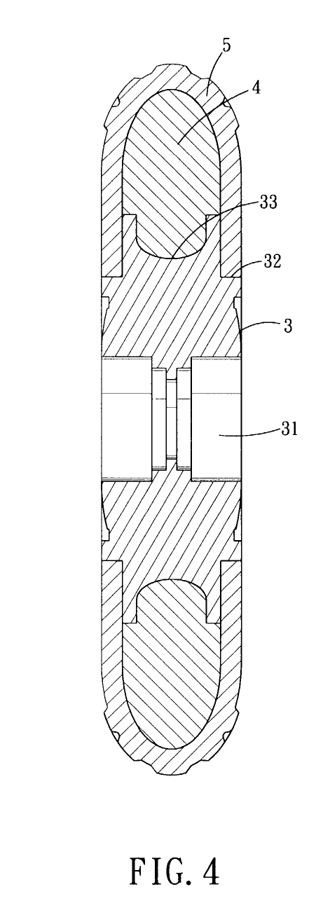

FIG. 4 shows another embodiment wherein a trend layer 5 made of Thermoplastic Elastomers is mounted to the tire 4 and the tire 4 is made to be narrower or have the same width with the ridge, so that the trend layer 5 is engaged with the shoulder portions 32.

While we have shown and described the embodiment in accordance with the present invention, it should be clear to those skilled in the art that further embodiments may be made without departing from the scope of the present invention.

What is claimed is:

1. A wheel assembly for child bicycles comprising:
a rim made of Polypropylene and having two shoulder portions, a groove located between the two shoulder portions in an outer periphery of the rim, and
an annular tire made of complex material which is compatible with the Polypropylene, the tire engaged with the groove and the shoulder portions of the rim.

2. The wheel assembly as claimed in claim 1, wherein the complex material is Thermoplastic Elastomers.

3. The wheel assembly as claimed in claim 1 further comprising a trend layer made of Thermoplastic Elastomers mounted to the tire and engaged with the shoulder portions.
